(19) United States
(12) Patent Application Publication
(10) Pub. No.: US 2020/0050931 A1
(43) Pub. Date: Feb. 13, 2020

(54) BEHAVIORIAL FINITE AUTOMATA AND NEURAL MODELS

(71) Applicant: International Business Machines Corporation, Armonk, NY (US)

(72) Inventors: Harish Bharti, Pune (IN); Kshitij Kashyap Raval, Hadapsar (IN); Abhay Patra, Pune (IN); Sarbajit K. Rakshit, Kolkata (IN); Sathya Santhar, Ramapuram (IN)

(21) Appl. No.: 16/058,215

(22) Filed: Aug. 8, 2018

(51) Int. Cl. G06N 3/08; G06N 3/04

(52) U.S. Cl. CPC G06N 3/08; G06N 3/0454

(57) ABSTRACT

Methods and systems for generating recommendation data to address behaviors exhibited by an entity are described. A processor may construct a finite automaton based on entity data associated with the entity. Each state of the finite automaton may represent a sentiment, and the finite automaton may accept a language representing a set of behaviors. The processor may receive a request comprising an input behavior string. The processor may apply the input behavior string on the finite automata to determine an output string. The processor may identify at least one neural model mapped to the output string, where the identified neural model comprises logic that facilitates interpretation of a cause of the behaviors among the input behavior string. The processor may generate the recommendation data using the identified neural model, where the recommendation data comprises a recommendation to address the behaviors among the input behavior string.

### FIELD

The present application relates generally to computers, and computer applications, and more particularly to computer-implemented methods and systems relating to recommendation systems based on finite automata and neural models.

### BACKGROUND

In some examples, computer systems may be trained to output recommendations to respond to specific behaviors exhibited by an entity, such as a person. The computer systems may be trained using machine learning algorithms, such as by using historical data related to behaviors and responses exhibited from a population. The trained computer systems may output recommendations that are known and cited by sources such as experts, books, theories, and/or other sources.

### SUMMARY

In some examples, methods for generating recommendation data to address behaviors exhibited by an entity are generally described. The methods may include receiving, by a processor, entity data related to the entity. The methods may further include constructing, by the processor, a finite automaton associated with the entity based on the entity data. The finite automaton may include a finite set of states, where each state may represent a sentiment and each state may be assigned with a symbol. The finite automaton may accept a language representing a set of behaviors. The methods may further include receiving, by the processor, a request comprising an input behavior string, where the input behavior string may include a sequence of at least one behavior. The methods may further include applying, by the processor, the input behavior string on the finite automaton to determine an output string. The output string may include a sequence of symbols assigned to a sequence of states among the finite set of states. The methods may further include identifying, by the processor, at least one neural model mapped to the output string. The identified neural model may include logic that facilitates interpretation of a cause of the behaviors among the input behavior string. The methods may further include generating, by the processor, recommendation data using the identified neural model. The recommendation data may include a recommendation to address the behaviors among the input behavior string.

In some examples, a system for generating recommendation data to address behaviors exhibited by an entity may be generally described. The system may include a memory configured to store a set of instructions. The system may further include a processor configured to be in communication with the memory. The processor may be configured to receive entity data related to an entity. The processor may be further configured to construct a finite automaton associated with the entity based on the entity data. The finite automaton may include a finite set of states, where each state may represent a sentiment and each state may be assigned with a symbol. The finite automaton may accept a language representing a set of behaviors. The processor may be further configured to receive a request comprising an input behavior string, where the input behavior string may include a sequence of at least one behavior. The processor may be further configured to apply the input behavior string on the finite automaton to determine an output string. The output string may include a sequence of symbols assigned to a sequence of states among the finite set of states. The processor may be further configured to identify at least one neural model mapped to the output string. The identified neural model may include logic that facilitates interpretation of a cause of the behaviors among the input behavior string. The processor may be further configured to generate recommendation data using the identified neural model. The recommendation data may include a recommendation to address the behaviors among the input behavior string.

In some examples, a computer program product for generating recommendation data to address behaviors exhibited by an entity is generally described. The computer program product may include a computer readable storage medium having program instructions embodied therewith. The program instructions may be executable by a processing element of a device to cause the device to perform one or more methods described herein.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an example computer system in one embodiment that can be utilized to implement behavioral finite automata and neural models in one embodiment.

FIG. 2 illustrates an example implementation of behavioral finite automata and neural models in one embodiment.

FIG. 3 illustrates an example implementation of behavioral finite automata and neural models in one embodiment.

FIG. 4 illustrates a flow diagram relating to behavioral finite automata and neural models in one embodiment.

FIG. 5 illustrates a schematic of an example computer or processing system that may implement behavioral finite automata and neural models in one embodiment.

FIG. 6 depicts a cloud computing environment according to an embodiment of the present invention.

FIG. 7 depicts abstraction model layers according to an embodiment of the present invention.

### DETAILED DESCRIPTION

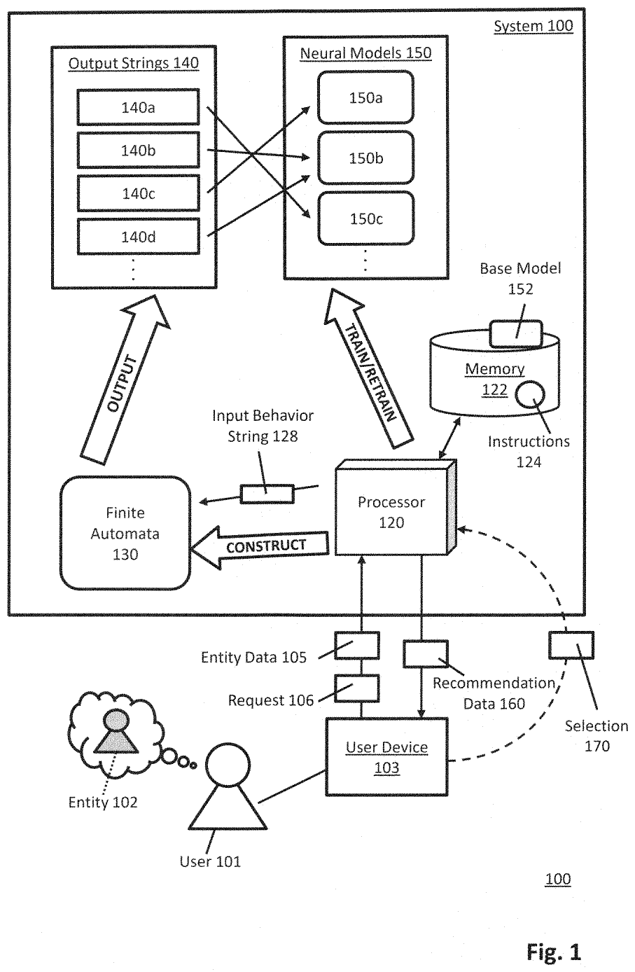

In some examples, different entities may have different attributes, and may exhibit different behaviors in response to different situations. A systematic approach to understand how an entity feels, and causes or triggers of behaviors exhibited by each entity may be useful. For example, a first entity may cry in response to a toy being taken away, while a second entity may not cry and move on to a next toy in response to be toy being taken away. As such, each entity may require unique guidance procedures to be driven towards positive behaviors in different situations. A system 100, shown in FIG. 1 and described below, may provide mechanisms to recommend procedures, such as actions and/or practices, that may be executed to guide entities toward positive behaviors, where each recommended procedure is tailored for a corresponding entity.

In an example, the system 100 may receive various information related to the entity, and may construct one or more finite automata representing the entity, and neural models that may be used to identify causes or triggers of any negative behavior exhibited by the entity. In an example, if an entity is always hyper-active, the system 100 may use the neural models to identify that the entity may be lacking time to play, hence recommend that the entity gets additional time to play at school and at home. In another example, an entity may be always fearful and not feeling confident to perform daily tasks, the system 100 may use the neural models to identify that a root cause could be the entity is frequently exposed to loud conversations and recommend avoiding exposing the entity to loud conversations. In another example, an entity may resist going to school, and the system 100 may use the neural models to identify potential bullying at school and recommend contacting the school. In another example, an entity may often wake up at the middle of the night, and the system 100 may use the neural models to evaluate all parameters and recommend bedtime routines.

FIG. 1 illustrates an example computer system 100 that can be utilized to implement determination of behavior response using finite automata, arranged in accordance with at least some embodiments described herein. In some examples, the system 100 may be a system implemented on a computer device. The system 100 may include a processor 120 and a memory 122 configured to be in communication with each other. The processor 120 may be a central processing unit of a computer device. In some examples, the processor 120 may be configured to control operations of the memory 122 and/or other components of the system 100. In some examples, the system 100 may include additional hardware components, such as programmable logic devices, microcontrollers, memory devices, and/or other hardware components, that may be configured to perform respective tasks of the methods described in the present disclosure. In some examples, the processor 120 may be configured to execute software modules that include instructions to perform each respective task of the methods described in the present disclosure. In some examples, the processor 120 and/or the memory 122 may be parts of resources provided by a cloud computing platform.

The memory 122 may be configured to selectively store instructions executable by the processor 120. For example, in one embodiment, the memory 122 may store a set of instructions 124, where the instructions 124 may include instructions, such as executable code, related to machine learning algorithms, finite automata construction algorithms, natural language processing algorithms, and/or other algorithms or techniques, which may implement the system 100. The processor 120 may be configured to execute one or more portions of the instructions 124 in order to facilitate implementation of the system 100. In some examples, the instructions 124 may be packaged as a standalone application that may installed on the computer device implementing the system 100, such that the instructions 124 may be executed by the processor 120 to implement the system 100. In some examples, the instructions 124 may be stored in a programmable hardware component that may be embedded as part of the processor 120.

The processor 120 may receive entity data 105, associated with one or more entities, from one or more data sources. For example, a user 101 may be a parent of an entity 102, and the user 101 may operate a user device 103 to provide entity data 105 related to the entity 102. Some example data sources that may also provide the entity data 105 may include monitors that may be monitoring behaviors of the entities, wearable devices, sensors, recorders, the Internet, and/or other devices and data sources. The entity data 105 may include 1) primary information associated with potential problem areas, 2) supporting information that may or may be a factor in identifying the potential problem areas, and 3) any past provoking factors which might have harm the entity. Some examples of the primary information may include negative behavior exhibited from the entities, pain point of the entities, body language of the entities, problem traits such as the time of the day in which particular problems or behaviors occur, the frequency of occurrences, and/or other information related to potential problems. Some examples of the supporting information may include age, eating habits, sleep routine, schedule, experiences with peers, family, and/or other companions, health, and/or other information. Some examples of past provoking factors may include past disturbing events experienced by the entities, permanent or temporary physical limitations, permanent or temporary mental limitations, and/or other factors.

The processor 120 may be configured to construct one or more finite automata 130 using the entity data 105. Each finite automaton 130 may correspond to a particular population, such as an age group, of entities. Each finite automaton 130 may be a construct defining an initial state and transitions to other states based on a defined transition function. For example, the states among the finite automata 130 may represent a state of mind of an entity, or sentiments, such as happy, sad, frustrated, anxious, jealous, and/or other sentiments that may be experienced by the entities, and the transitions from state to state may represent behaviors, such as crying, screaming, throwing tantrums, hyper activity, sharing, and/or other behaviors that may be exhibited by the entities. As such, each finite automaton 130 may represent how entities of particular populations (e.g., age groups) behave while transitioning from one sentiment to another sentiment, such as crying when transitioning from a happy state to a sad state. Thus, each finite automaton 130 may include a finite set of states that may accommodate all combinations of behaviors exhibited by the entities, with each behavior having a starting state and an ending state. In some examples, the finite automata 130 may be deterministic finite automata. In some examples, the finite automata 130 may be non-deterministic finite automata, where each state may be transitioned to one or more states.

In an example, each finite automaton 130 may be denoted as M=(Q, Σ, q₀, F), where M may be a finite state machine with finite states Q, an alphabet of symbols Σ, such as {0,1}, a starting state q₀, a final state F, and a transition function d: Q×Σ→Q such that M accepts a language L. The finite states Q may include one or more states representing sentiments that may be experienced by the entities. Outputs of each state among the finite states Q may be represented by a symbol among the alphabet Σ. The language L may represent a set of behaviors that may be exhibited by the entities. The behaviors represented by the language L may include positive and/or negative behaviors. In an example, the behaviors represented by the language L may be labeled, such as:
A→crying
B→not eating
C→remain silent
   As such, L may be expressed as L={A, B, C, AB, BC, A²B, AB³, . . . }. An entity may exhibit more than one behavior at a time. For example, an entity that was crying first, then stopped crying and refuse to eat, may be expressed as {A, B} since the entity exhibit one behavior at a time. In another example, an entity that was crying first, then continue to cry and also refuse to eat, may be expressed as {A, AB} since the entity exhibit the crying behavior at a first time, then exhibit both crying and refusing to eat behaviors at a second time.

Also, it is noted that some behaviors may be quantified based on a severity level. For example, A alone may denote a lowest level of the behavior, while A² may denote a slightly more severe level of the behavior, and A⁴ may denote a particularly high severe level of the behavior. In some examples, the behaviors may be quantified with respect to various factors, and the quantification may depend on a desired implementation of the system 100. For example, A may denote an entity crying for one minute, A² may denote the entity crying for three minutes, and so on. In another example, a behavior such as “use of abusive words” may be quantified based on a number of words, such as A may denote three words in an instance, and A² may denote is more than three words, and so on. In some examples, there may be behaviors that cannot be quantified, such as sharing a toy.

The processor 120 may construct the finite automata 130 based on historical references of entities belonging to similar categories, such as age group. For example, there may be a first finite automaton constructed for entities ranging from X years old to Y years old, and there may be a second finite automaton constructed for entities ranging from U years old to V years old. In order to construct the finite automata for a particular category, the entity data 105 may include sample sets of entities in that particular category. In some examples, the processor 120 may construct the finite automata 130 based on observations and references. In some examples, the processor 120 may construct the finite automata 130 as non-deterministic finite automata then subsequently, convert the non-deterministic finite automata into deterministic finite automata. In some examples, the processor 120 may construct the finite automata 130 as deterministic finite automata then subsequently, convert the deterministic finite automata into non-deterministic finite automata.

In some examples, as the amount of sample sets among the entity data 105 increases, the processor 120 may construct new finite automata, or update existing finite automata, such that the system 100 utilized a more granular set of finite automata. The instructions 124 may define a threshold in which the processor 120 may partition the data being used to construct the finite automata 130. For example, the finite automata 130 may be finite state machines constructed based on ten thousand sample sets of entities ranging from X years old to Y years old. The instructions 124 may indicate that upon receiving one million sample sets of entities ranging from X years old to Y years old, partition the one million sample sets and construct a plurality of finite state machines for ages X, X+1, . . . Y. Thus, the plurality of finite state machines may be more customized for each category because, for example, a X years old entity may transition from happy to sad while exhibiting a particular behavior, while a Y years old entity may transition from happy to sad while exhibiting a different behavior. The processor 120 may continuously monitor for new entity data 105 to determine whether it is necessary to construct or update each finite automaton 130.

Outputs from each finite automaton 130 may represent how entities transition from one state to another state. For example, a first entity may transition from a happy state to a sad state through a first sequence of behaviors{A, B}, whereas a second entity may transition from a happy state to a sad state through a second sequence of behaviors{A, B, AB}. The processor 120 may determine one or more, or all of, the possible combination of sequence of behaviors that may be outputted from each finite automaton 130. The processor 120 may be configured to assign each sequence of behaviors with a respective string of symbols among the alphabet Σ, where the set of assigned string of symbols may be stored as output strings 140 in the memory 122 (including output strings 140a, 140b, 140c, 140d). In examples where the alphabet Σ includes the set of symbols {0, 1}, each output string 140 may be a string of binary numbers.

The processor 120 may be further configured to construct one or more neural machines, or neural models 150 (including neural models 150a, 150b, 150c), for each output string 140 of each finite automaton 130. The construction of the neural models 150 may be based on the state of the entities associated with corresponding labeled parameters, or behaviors. Each output string 140 may be mapped, by the processor 120, to one or more neural models 150, and each neural model 150 may be mapped to one or more output strings 140. In an example, the mappings between the output strings 140 and the neural models 150 may be stored in the memory 122. The processor 120 may use the mappings between the output strings 140 and the neural models 150 to identify particular neural models that may represent best actions and best practices that the users of system 100 may follow to address behaviors of the entities.

The processor 120 may construct the neural models 150 based on the entity data 105. In an example, the entity data 105 may include unstructured data collected from the user 101, the entity 102, and/or other users, entities, and data sources. The processor 120 may execute natural language processing and machine learning algorithms (which may be among the instructions 124 stored in the memory 122) to classify and annotate the unstructured data among the entity data 105. The processor 120 may capture the potential causal factors impacting social and psychological behavior of the entities from the classified and annotated data in order to train the neural models 150.

In an example, the entity data 105 may be used by the processor 120 to construct both the finite automata 130 and the neural models 150. For example, a sample set among the entity data indicates a situation where an entity was happy while eating and watching television, then upon turning off the television, the entity starts crying and refuse to eat and becomes upset. The processor 120 may extract the portions indicating “happy”, “crying”, “refuse to eat”, “upset” to construct and/or update a finite automaton 130 associated with the entity. The processor 120 may extract the portions indicating “happy while eating and watching television”, “turn off television”, “upset” to train a neural model associated with the entity, such that the trained neural model may learn the probability of turning off the television being a cause of the entity changing from a happy state to a upset state. Thus, the neural models 150 trained by the processor 120 may include one or more hidden layers of logic that may interpret causes and effects of actions and/or practices being executed by users (e.g., parents) on the entities.

In some examples, as the system 100 receives new entity data, the processor 120 may add or remove the finite automata 130 and/or the neural models 150 accordingly. The processor 120 may further modify mappings of the between the finite automata 130 and the neural models 150 in response to the additions and removals.

In an example, each behavior that may be exhibited by the entities (behaviors among the language L) may be a response to particular actions and/or triggers. The actions and/or triggers may be assigned with confidence values that indicate a type and extent of the behavior. In some examples, the confidence values may be based on historical data associated with the entities. For example, historically, an entity may exhibit a first level of behavior A and a second level of behavior B, and an action S has resolved the problems caused by the exhibited levels of behaviors. Thus, the processor 120 may assign confidence values to the action S to indicate that the action S may address behaviors A and B to a certain extent. In some examples, the confidence values can be received from sources such as experts, consultants, questionnaires, records, and/or other sources.

In some examples, the memory 122 may be configured to store a base model 152 that may be used by processor 120 to train the different neural models 150 for different output strings 140. For example, the base model 152 may be a pre-determined neural model with pre-determined weights. The processor 120 may train the base model 152 using a first portion of the entity data 105 that correspond to entities of a first category to construct a first neural model, and may train the same base model 152 using a second portion of the entity data 105 that correspond to entities of a second category to construct a second neural model. The pre-determined weights in the base model 152 may be adjusted over time as the base model 152 is being trained by the processor 120 to construct different neural models 150. In some examples, the processor 120 may adjust the weights of the model being trained based on the confidence values that indicate the type and extent of the behaviors. The processor 120 may continue to train the different neural models 150 with new data that are received at the system 100.

By continuously retraining the neural models 150, the neural models 150 may achieve higher degrees of accuracy based on the increase of the number of input sample sets. In an example, the base model 152 stored in the memory 122 may be a neural model previously constructed based on historical data and/or pre-determine data, such as dummy variables, of entities ranging from X years old to Y years old. The base model 152 may be considered as a heterogeneous model, and the historical data that was used may be considered as heterogeneous data, or heterogeneous inputs, due to the wide range of age among the entities. Thus, the accuracy of the base model 152 may be relatively low. For example, a recommendation based on the base model 152 to address negative behavior exhibited from a X years old entity may be inaccurate since the base model may also be constructed based on data from a X+2 years old entity. As the amount of sample sets are increased and being used by the processor 120 to continuously train the neural model for entities ranging from X years old to Y years old, the trained neural model may eventually become a homogenous model, such as a neural model that represent entities that are more similar to each other. For example, a homogeneous model may correspond to entities that are X years old, and another homogeneous model may be constructed for entities that are X+1 years old. The instructions 124 may define a threshold in which the processor 120 may partition the data being used to train the base model and/or the neural models. For example, the base model 152 may be a heterogeneous model trained by ten thousand sample sets of entities ranging from X years old to Y years old. The instructions 124 may indicate that upon receiving one million sample sets of entities ranging from X years old to Y years old, partition the one million sample sets and train five homogeneous models for ages one, two, three, four, five. In other words, when the amount of sample sets reaches the threshold, instead of training one heterogeneous model, the processor 120 may partition the sample sets and may train more than one homogeneous models using the partitioned sample sets.

Also, by continuously retraining the neural models, the corresponding parameters and the level of confidence of the neural models may grow as the system 100 learns and adjusts the parameters, remove, or add any variables. Probability distributions associated with heterogeneous neural models may be updated with evidence such that the system 100 may train homogenous models that may be more accurate than heterogeneous models. Thus, the use of neural models in accordance with the present disclosure may provide a solution to address negative behaviors while considering an exhaustive amount of information that may impact an entity, and also while considering changes of the information, the impact, and the entity over time. The finite automata provide a structured foundation to learn different neural models relating to an exhaustive amount of behavior combinations. The system in accordance with the present disclosure may use the finite automata and the neural models mapped to each unique behavior sequence to provide recommendations that are more customized and granular, and allow the users to understand reasons and triggers for negative behaviors exhibited by the entities.

Further, by training the neural models with sample sets from entities of a same category, the system 100 may provide recommendations including actions and practices that may be previously unknown to a user requesting the recommendation. In other words, a user requesting a recommendation to address a negative behavior exhibited by an entity may be provided with recommendations including actions and practices that were unknown to the user, and have been successful, in addressing the negative behavior exhibited by other entities in a same category. As the system 100 received additional data, the processor 120 may retrain the neural models to update any new actions or practices that may address negative behaviors.

In some examples, the finite automata 130 constructed by the processor 120 may be mapped to, or directed to, more than one neural models 150. For example, an entity may exhibit a sequence of behaviors {A, C, B} in a corresponding finite automaton 130. An output string 140 corresponding to the sequence {A, C, B} may be mapped to a first neural model that may recommend an immediate, or a short term, solution, and may also be mapped to a second neural model that may suggest a long term solution, while considering the period during which the behavior is exhibited. In some examples, some behaviors may not need long term solution and may not result in mappings to multiple neural models. In some examples, the processor 120 may classify the output strings 140, such as short term solution may be preferable over long term solution for particular output strings 140, and vice versa.

In an example, the user 101 may use the user device 103 to send a request 106 to the system 100. The request 106 may include an input behavior string 128, where the input behavior string may include a sequence of at least one behavior exhibited by the entity 102. For example, the request 106 may be a request for recommendations on how to respond to the entity 102 crying, then refusing to eat and crying, then stopped crying but still refuse to eat, such that the input behavior string 128 may be {A, AB, B}. The processor 120 may identify a finite automaton 130 associated with the entity 102, such as identifying a finite automaton 130 that represents an age group where the entity 102 belongs to. The processor 120 may apply the input behavior string 128 on the identified finite automaton 130 to determine an output string 140. The processor 120 may identify one or more neural models 150 that are mapped to the determined output string 140. The processor 120 may generate recommendation data 160 based on the identified one or more neural models 150, where the recommendation data 160 may include a recommendation for the user 101 to perform a set of actions and/or practices that may address the behaviors indicated by the request 106.

In some examples, the recommendation data 160 maybe multi-classed and the practices suggested may include giving interesting educational gifts, talking out, leaving the entity alone for some time, and/or other practices. The recommendation data 160 that is based on a long term neural model may include a set of practices to be followed, and a time frame may be suggested, such as counseling procedures, trainings, changing the environment and/or other practices. In some examples, the recommendation data 160 may include more than one recommendation such that the user 101 may make a selection 170 to select a particular recommendation. For example, the user 101 executing a first action may make the entity happy and interactive, but execution of a second action may make the entity silent. Thus, a user who may be occupied may select the second action but a user in other situations may select the first action. Upon the selection 170 being made by the user 101, the selection 170 may be provided to the system 100, such that the processor 120 may learn the reasons for the selection 170 and whether the selected actions have worked. Therefore, the system 100 continues to learn and update the finite automata 130 and the neural models 150 based on new data, such as the selection 170. In some examples, the system 100 may continue to learn and update the finite automata 130 and the neural models 150 associated with the entity 102 until the user 101 indicates that the entity 102 no longer exhibits negative behaviors.

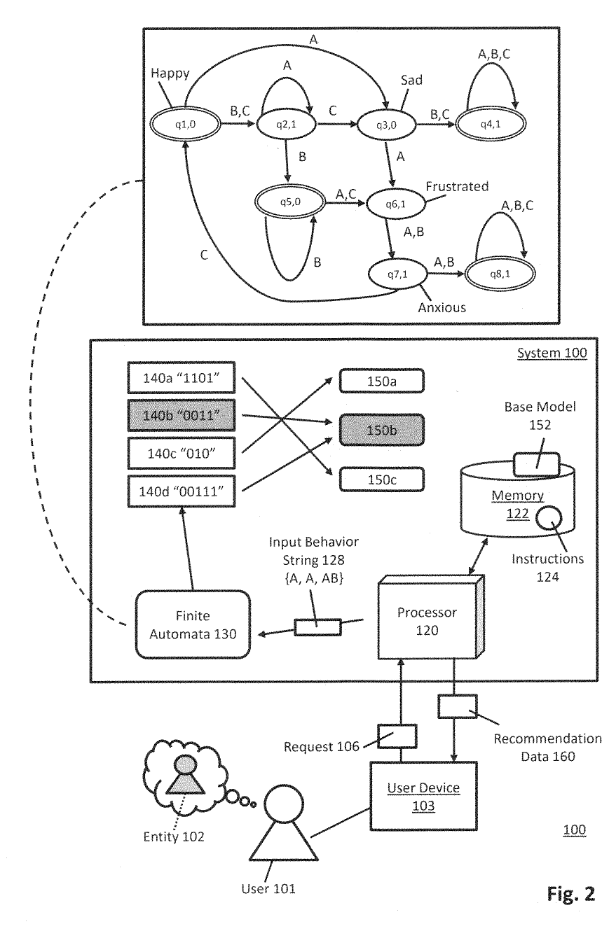

FIG. 2 illustrates an example process of a phase of an implementation of the example system of FIG. 1, arranged in accordance with at least some embodiments described herein. FIG. 2 may be described below with references to the above descriptions of FIG. 1.

In an example shown in FIG. 2, the request 106 may include the input behavior string 128 indicating {A, A, AB}, which represents a sequence of behaviors “crying, crying, crying and not eating”. The processor 120 may identify the finite automaton 130 associated with the entity 102. The identified finite automaton 130 may include a plurality of states, such as states “q1, q2, q3, q4, q5, q6, q7, q8”. Each state may be assigned to a symbol, such as, states “q1, q2, q3, q4, q5, q6, q7, q8” are assigned to symbols “0, 1, 0, 1, 0, 1, 1, 1”, respectively. In the example shown in FIG. 2, the state “q1” may represent the sentiment “happy”, the state “q3” may represent the sentiment “sad”, the state “q6” may represent the sentiment “frustrated”, and the state “q7” may represent the sentiment “anxious”. The processor 120 may use the input behavior string 128 to drive the identified finite automaton 130, such as by applying the input behavior string 128 on the identified finite automaton 130, to determine an output string 140. For example, the processor 120 may start at a start state, “q1”, of the finite automaton 130, and may determine which state will the first behavior among the input behavior string 128 (A) transition to. By analyzing the finite automaton 130, the processor 120 may determine that the behavior A drives the finite automaton 130 from state “q1” to state “q3, where the state “q1” may output the symbol “0” and the state “q3” may output the symbol “0”. Thus, the processor 120 may determine that based on the input behavior string 128 of {A, A, AB}, the finite automaton 130 may output “0011” based on a sequence of states “q1→q3→q6→q7”. The processor 120 may identify the output string “0011” among the output strings 140, which in this example, is the output string 140b. The processor 120 may use the mappings stored in the memory 122 to identify the neural model 150b is mapped to the output string 140b. The processor 120 may then use the neural model 150b to generate the recommendation data 160.

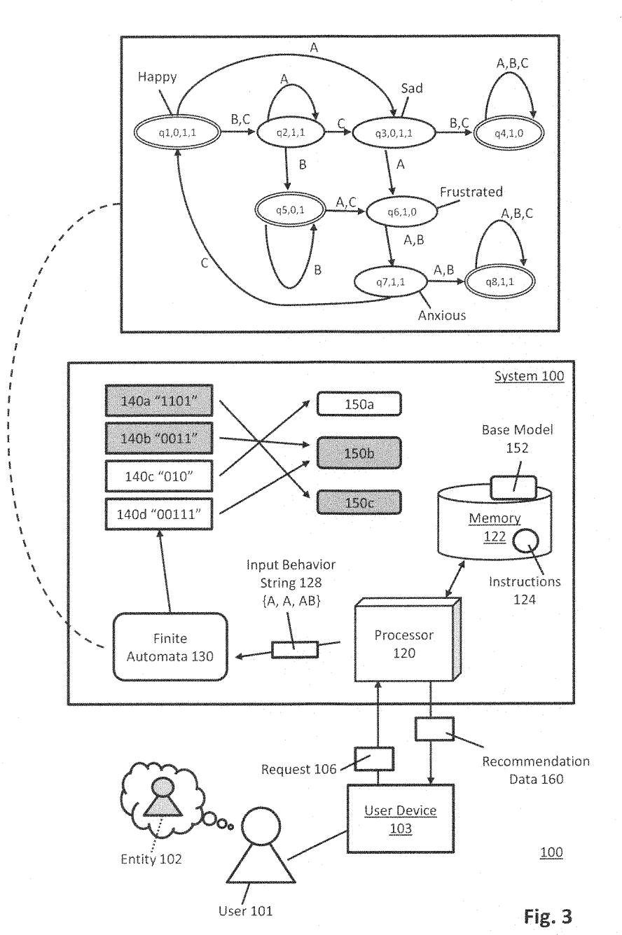

FIG. 3 illustrates an example process of a phase of an implementation of the example system of FIG. 1, arranged in accordance with at least some embodiments described herein. FIG. 3 may be described below with references to the above descriptions of FIGS. 1-2.

In an example shown in FIG. 3, the request 106 may include the input behavior string 128 indicating {A, A, AB}, which represents a sequence of behaviors “crying, crying, crying and not eating”. The processor 120 may identify the finite automaton 130 associated with the entity 102. The identified finite automaton 130 may include a plurality of states, such as states “q1, q2, q3, q4, q5, q6, q7, q8”. Each state may be assigned to more than one symbols. For example, state “q1” may be assigned to symbols “0, 1, 1”, state “q3” may be assigned to symbols “0, 1, 1”, state “q6” may be assigned to symbols “1, 0”, and state “q7” may be assigned to symbols “1, 1”. In the example shown in FIG. 3, the state “q1” may represent the sentiment “happy”, the state “q3” may represent the sentiment “sad”, the state “q6” may represent the sentiment “frustrated”, and the state “q7” may represent the sentiment “anxious”.

The processor 120 may determine that based on the input behavior string 128 of {A, A, AB}, the finite automaton 130 may output “0011” based on a sequence of states “q1→q3→q6→q7” and the first assigned symbols for the states “q1, q3, q6, q7”. The processor 120 may also determine that based on the input behavior string 128 of {A, A, AB}, the finite automaton 130 may also output “1101” based on a sequence of states “q1→q3→q6→q7” and the second assigned symbols for the states “q1, q3, q6, q7”. The processor 120 may identify the output strings “1101” and “0011” among the output strings 140, which in this example, are the output strings 140a, 140b. The processor 120 may use the mappings stored in the memory 122 to identify the neural models 150c, 150b are mapped to the output strings 140a, 140b, respectively. The processor 120 may then use the neural models 150b, 150c to generate the recommendation data 160. Thus, the recommendation data 160 may include recommendations of two different actions that are based on neural models 150b, 150c. In an example, the two different actions may be recommendations of different approaches to address the behaviors indicated by the request 106. In another example, one of the two actions may be a recommended short-term solution, and the other one of the two actions may be a recommended long-term solution. Therefore, the user 101 may make the selection 170 among the two recommendations indicated by the recommendation data 160.

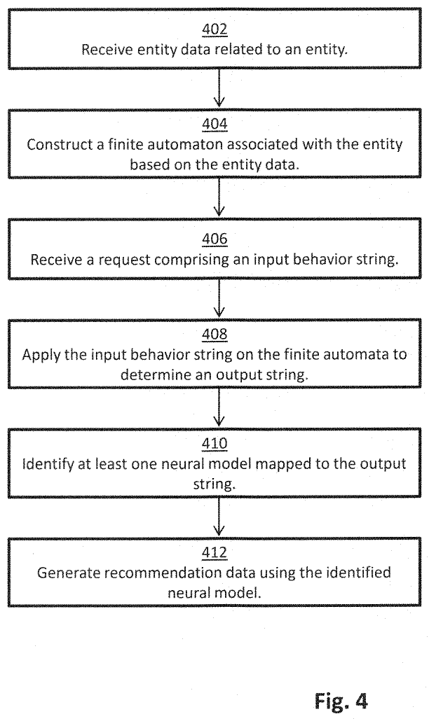

FIG. 4 illustrates a flow diagram relating to patient engagement communicative strategy recommendation, arranged in accordance with at least some embodiments presented herein. The process in FIG. 4 may be implemented using, for example, computer system 100 discussed above. An example process may include one or more operations, actions, or functions as illustrated by one or more of blocks 402, 404, 406, 408, 410, and/or 412. Although illustrated as discrete blocks, various blocks may be divided into additional blocks, combined into fewer blocks, eliminated, or performed in parallel, depending on the desired implementation.

Processing may begin at block 402, where a processor may receive entity data related to an entity.

Processing may continue from block 402 to block 404. At block 404, the processor may construct a finite automaton associated with the entity based on the entity data. The finite automaton may include a finite set of states, where each state may represent a sentiment and each state may be assigned with a symbol among an alphabet. The finite automaton may accept a language representing a set of behaviors.

Processing may continue from block 404 to block 406. At block 406, the processor may receive a request comprising an input behavior string. The input behavior string may include a sequence of at least one behavior.

Processing may continue from block 406 to block 408. At block 408, the processor may apply the input behavior string on the finite automata to determine an output string. The output string may include a sequence of symbols assigned to a sequence of states among the finite set of states.

Processing may continue from block 408 to block 410. At block 410, the processor may identify at least one neural model mapped to the output string. The identified neural model may include logic that facilitates interpretation of a cause of the behaviors among the input behavior string.

Processing may continue from block 410 to block 412. At block 412, the processor may generate recommendation data using the identified neural model. The recommendation data may include a recommendation to address the behaviors among the input behavior string.

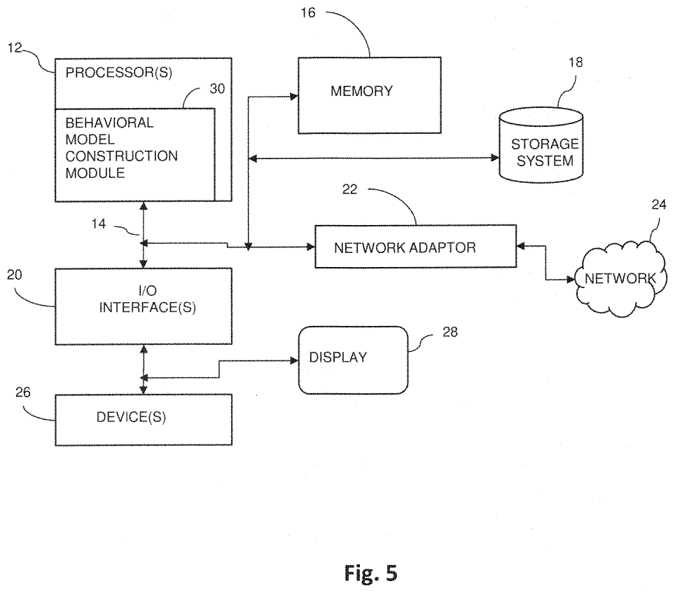

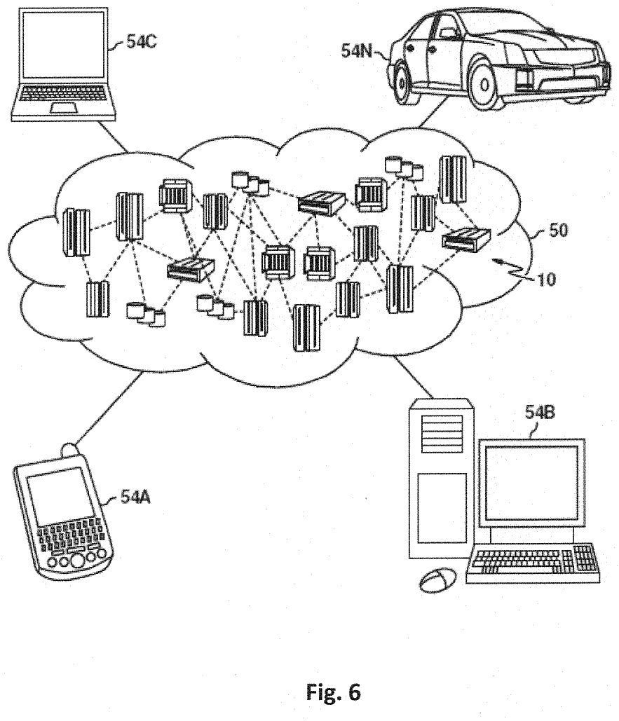

FIG. 5 illustrates a schematic of an example computer or processing system that may implement patient engagement communicative strategy recommendation in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, supercomputers, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 (e.g., behavioral model construction module 30) that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

FIG. 6 depicts a cloud computing environment according to an embodiment of the present invention. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

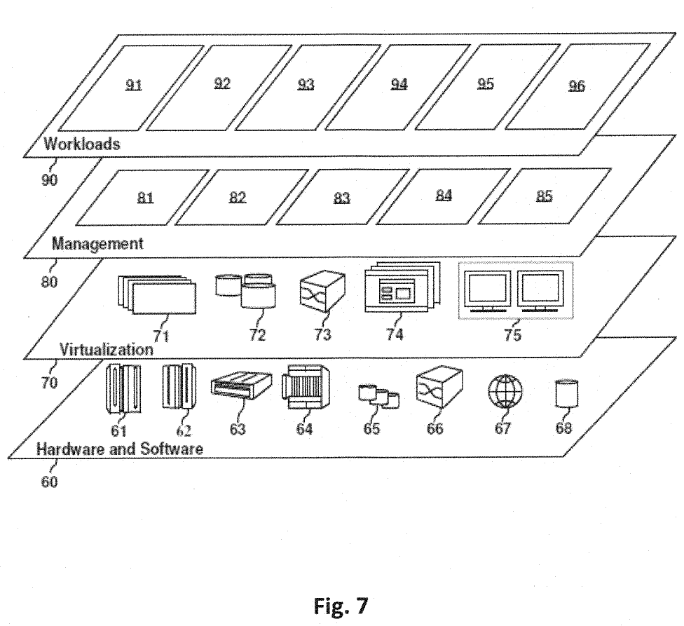

FIG. 7 depicts abstraction model layers according to an embodiment of the present invention. Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and behavioral model construction 96.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving, by a processor, entity data related to an entity;
constructing, by the processor, a finite automaton associated with the entity based on the entity data, wherein the finite automaton comprises a finite set of states, each state represents a sentiment and each state is assigned with a symbol, and the finite automaton accepts a language representing a set of behaviors;
receiving, by the processor, a request comprising an input behavior string, wherein the input behavior string comprises a sequence of at least one behavior;
applying, by the processor, the input behavior string on the finite automaton to determine an output string, wherein the output string comprises a sequence of symbols assigned to a sequence of states among the finite set of states;
identifying, by the processor, at least one neural model mapped to the output string, wherein the identified neural model comprises logic that facilitates interpretation of a cause of the behaviors among the input behavior string; and
generating, by the processor, recommendation data using the identified neural model, wherein the recommendation data comprises a recommendation to address the behaviors among the input behavior string.

2. The method of claim 1, wherein the association between the finite automaton and the entity is based on an age of the entity.

3. The method claim 1, further comprising training, by the processor, the neural model based on the entity data.

4. The method of claim 3, wherein training the neural model comprises:
retrieving, by the processor, a base model from a memory, wherein the base model comprises pre-determined weights of input nodes of the neural model; and
adjusting, by the processor, the pre-determined weights based on the entity data.

5. The method of claim 3, wherein the entity data comprises a first amount of sample sets, and training the neural model comprises:
receiving, by the processor, additional sample sets;
determining, by the processor, that a amount of received sample sets is greater than a threshold;
in response to the amount of received sample sets being greater than the threshold, partitioning, by the processor, the entity data based on a category;
training, by the processor, a first neural model using a first partition of the entity data that corresponds to a first category; and
training, by the processor, a second neural model using a second partition of the entity data that corresponds to a second category.

6. The method of claim 5, further comprising:
constructing, by the processor, a first finite automaton using the first partition of the entity data; and
constructing, by the processor, a second finite automaton using the second partition of the entity data.

7. The method of claim 1, further comprising:
receiving, by the processor, a selection of an action to address the behaviors among the input behavior string, wherein the selection is based on the recommendation in the recommendation data;
updating, by the processor, the finite automaton based on the received selection; and
retraining, by the processor, the neural model based on the received selection.

8. The method of claim 1, wherein identifying the at least one neural model includes:
identifying a first neural model corresponding to a short-term solution in addressing the input behavior string; and
identifying a second neural model corresponding to a long-term solution in addressing the input behavior string.

9. A system comprising:
a memory configured to store a set of instructions;
a processor configured to be in communication with the memory, the processor being configured to execute the set of instructions stored in the memory to:
receive entity data related to an entity;
construct a finite automaton associated with the entity based on the entity data, wherein the finite automaton comprises a finite set of states, each state represents a sentiment and each state is assigned with a symbol, and the finite automaton accepts a language representing a set of behaviors;
receive a request comprising an input behavior string, wherein the input behavior string comprises a sequence of at least one behavior;
apply the input behavior string on the finite automaton to determine an output string, wherein the output string comprises a sequence of symbols assigned to a sequence of states among the finite set of states;
identify at least one neural model mapped to the output string, wherein the identified neural model comprises logic that facilitates interpretation of a cause of the behaviors among the input behavior string; and
generate recommendation data using the identified neural model, wherein the recommendation data comprises a recommendation to address the behaviors among the input behavior string.

10. The system of claim 9, wherein the association between the finite automaton and the entity is based on an age of the entity.

11. The system claim 9, wherein the processor is further configured to train the neural model based on the entity data.

12. The system of claim 11, wherein the processor is further configured to:
retrieve a base model from the memory, wherein the base model comprises pre-determined weights of input nodes of the neural model; and
adjust the pre-determined weights based on the entity data to train the neural model.

13. The system of claim 11, wherein the entity data comprises a first amount of sample sets, and the processor is further configured to:
receive additional sample sets;
determine that a amount of received sample sets is greater than a threshold;
in response to the amount of received sample sets being greater than the threshold, partition the entity data based on a category;
train a first neural model using a first partition of the entity data that corresponds to a first category; and
train a second neural model using a second partition of the entity data that corresponds to a second category.

14. The system of claim 13, wherein the processor is further configured to:
construct a first finite automaton using the first partition of the entity data; and
construct a second finite automaton using the second partition of the entity data.

15. The system of claim 9, wherein the processor is further configured to:
receive a selection of an action to address the behaviors among the input behavior string, wherein the selection is based on the recommendation in the recommendation data;
update the finite automaton based on the received selection; and
retrain the neural model based on the received selection.

16. The system of claim 9, wherein the processor is further configured to:
identify a first neural model corresponding to a short-term solution in addressing the input behavior string; and
identify a second neural model corresponding to a long-term solution in addressing the input behavior string.

17. A computer program product for generating recommendation data to address behaviors exhibited by an entity, the computer program product comprising a computer readable storage medium having program instructions embodied therewith, the program instructions executable by a processing element of a device to cause the device to:
receive entity data related to the entity;
construct a finite automaton associated with the entity based on the entity data, wherein the finite automaton comprises a finite set of states, each state represents a sentiment and each state is assigned with a symbol, and the finite automaton accepts a language representing a set of behaviors;
receive a request comprising an input behavior string, wherein the input behavior string comprises a sequence of at least one behavior;
apply the input behavior string on the finite automata to determine an output string, wherein the output string comprises a sequence of symbols assigned to a sequence of states among the finite set of states;
identify at least one neural model mapped to the output string, wherein the identified neural model comprises logic that facilitates interpretation of a cause of the behaviors among the input behavior string; and
generate recommendation data using the identified neural model, wherein the recommendation data comprises a recommendation to address the behaviors among the input behavior string.

18. The computer program product of claim 17, wherein the program instructions are further executable by the processing element of the device to cause the device to:
retrieve a base model from a memory, wherein the base model comprises pre-determined weights of input nodes of the neural model; and
adjust the pre-determined weights based on the entity data.

19. The computer program product of claim 18, wherein the entity data comprises a first amount of sample sets, the program instructions are further executable by the processing element of the device to cause the device to:
receive additional sample sets;
determine that a amount of received sample sets is greater than a threshold;
in response to the amount of received sample sets being greater than the threshold, partition the entity data based on a category;
train a first neural model using a first partition of the entity data that corresponds to a first category;
train a second neural model using a second partition of the entity data that corresponds to a second category;
construct a first finite automaton using the first partition of the entity data; and
construct a second finite automaton using the second partition of the entity data.

20. The computer program product of claim 17, wherein the entity data comprises a first amount of sample sets, the program instructions are further executable by the processing element of the device to cause the device to:
receive a selection of an action to address the behaviors among the input behavior string, wherein the selection is based on the recommendation in the recommendation data;
update the finite automaton based on the received selection; and
retrain the neural model based on the received selection.
